(19) United States
(12) Patent Application Publication
(10) Pub. No.: US 2025/0215354 A1
(43) Pub. Date: Jul. 3, 2025

(54) FLUX CLEANING COMPOSITION

(71) Applicant: NAN YA PLASTICS CORPORATION, TAIPEI (TW)

(72) Inventors: TE-CHAO LIAO, TAIPEI (TW); CHENG-LI CHAO, TAIPEI (TW); Hsiu-Ping Lai, TAIPEI (TW)

(21) Appl. No.: 18/610,224

(22) Filed: Mar. 19, 2024

(30) Foreign Application Priority Data
Dec. 27, 2023 (TW) 112150903

(51) Int. Cl. C11D 1/88; C11D 3/00; C11D 3/04; C11D 3/075; C11D 3/12; C11D 3/20; C11D 3/34; C11D 3/43

(52) U.S. Cl. CPC C11D 1/88; C11D 3/0047; C11D 3/046; C11D 3/075; C11D 3/122; C11D 3/2086; C11D 3/3427; C11D 3/43; C11D 2111/16

(57) ABSTRACT

A flux cleaning composition is provided. The flux cleaning composition, based on a total weight thereof being 100%, includes: 2% to 20% of an amphoteric surfactant; 0.1% to 2% of a reducing agent; 5% to 10% of a chelating agent; 70% to 90% of an organic solvent; and 5% to 20% of water.

### CROSS-REFERENCE TO RELATED PATENT APPLICATION

This application claims the benefit of priority to Taiwan Patent Application No. 112150903, filed on Dec. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a cleaning composition, and more particularly to a flux cleaning composition.

### BACKGROUND OF THE DISCLOSURE

Soldering is usually performed during electronic assembly. Since an oxide layer is easily formed on a metal surface of a solder joint under a high temperature, a solder material (e.g., tin) is not likely to be adhered to the metal surface. Hence, a flux is used in the soldering process for chemically removing the oxide layer on the soldered metal surface and preventing surface reoxidation during soldering, so as to facilitate tin soldering. However, solder and flux residues may remain in gaps of a printed circuit board, which can cause difficulty in cleaning.

Since rosin is usually used as the main component of the flux, haloalkanes (e.g., fluorocarbons) are conventionally used to clean a rosin flux. However, the haloalkanes are extremely toxic and carcinogenic to the human body. In addition, volatile haloalkanes are harmful to the ozone layer. Through precipitation and surface runoff, the volatile haloalkanes may be distributed and cycled in the atmosphere, the water, and the earth, thereby negatively affecting the environment.

Therefore, how to develop a flux cleaning composition that is effective for cleaning and eco-friendly through improvements in composition and formula, so as to overcome the above-mentioned problems, has become one of the important issues to be solved in the relevant industry.

### SUMMARY OF THE DISCLOSURE

In response to the above-referenced technical inadequacies, the present disclosure provides a flux cleaning composition.

In order to solve the above-mentioned problems, one of the technical aspects adopted by the present disclosure is to provide a flux cleaning composition. The flux cleaning composition, based on a total weight thereof being 100%, includes: 2% to 20% of an amphoteric surfactant; 0.1% to 2% of a reducing agent; 5% to 10% of a chelating agent; 70% to 90% of an organic solvent; and 5% to 20% of water.

In one of the possible or preferred embodiments, the amphoteric surfactant is alkanolamine.

In one of the possible or preferred embodiments, the amphoteric surfactant is polyoxypropylene propyl ether, lauryl betaine, cocamidopropyl betaine, 3,7,11-trimethyldodecan-3-ol, neopentyl glycol dinonanoate, ethambutol, N,N′-bis(3-aminopropyl)-1,3-propanediamine, di(3-aminopropoxy)ethane, or a mixture thereof.

In one of the possible or preferred embodiments, the reducing agent is tin(II) chloride, iron(II) sulfate, titanium(III) chloride, reduced iron powder, oxalic acid, sodium thiosulfate, sodium sulfite, hypophosphorous acid, dithiothreitol, or a mixture thereof.

In one of the possible or preferred embodiments, the chelating agent is ethylenediamine, 2,2′-bipyridine, 1,10-phenanthroline, oxalate, ethylenediaminetetraacetic acid, 1,2-bis(dimethylarsino)benzene, citric acid, malic acid, or a mixture thereof.

In one of the possible or preferred embodiments, the organic solvent is ethylene glycol monoalkyl ether, ethylene glycol monophenyl ether, diethylene glycol monophenyl ether, diethylene glycol monoalkyl ether, dipropylene glycol monoalkyl ether, diethylene glycol dialkyl ether, or a mixture thereof.

In one of the possible or preferred embodiments, a content of the amphoteric surfactant ranges between 5% and 10%.

In one of the possible or preferred embodiments, a content of the reducing agent ranges between 0.5% and 1%.

In one of the possible or preferred embodiments, a content of the chelating agent ranges between 6% and 8%.

In one of the possible or preferred embodiments, a content of the organic solvent ranges between 80% and 85%.

In one of the possible or preferred embodiments, a content of the water ranges between 8% and 13%.

In one of the possible or preferred embodiments, a flash point of the organic solvent ranges between 100° C. and 110° C.

In one of the possible or preferred embodiments, a pH of the organic solvent ranges between 8 and 9.

In one of the possible or preferred embodiments, a weight ratio of the amphoteric surfactant to the reducing agent ranges between 15:1 and 20:1.

In one of the possible or preferred embodiments, a chroma of the flux cleaning composition is less than 15 G after being heated at 95° C. for 168 hours.

Therefore, in the flux cleaning composition provided by the present disclosure, by virtue of “the flux cleaning composition, based on a total weight thereof being 100%, including: 2% to 20% of an amphoteric surfactant; 0.1% to 2% of a reducing agent; 5% to 10% of a chelating agent; 70% to 90% of an organic solvent; and 5% to 20% of water,” a formula that does not contain haloalkanes but is still capable of effectively cleaning a flux can be provided, so as to replace a conventional haloalkane-based cleaning agent.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure provides a flux cleaning composition. Specifically, the flux cleaning composition provided by the present disclosure does not contain halogenated hydrocarbon. In order to enable the flux cleaning composition that does not contain the halogenated hydrocarbon to still have a good cleaning ability for a rosin flux, an amphoteric surfactant can be used instead of the halogenated hydrocarbon for providing a cleaning effect in the present disclosure. Here, the amphoteric surfactant is alkanolamine.

For example, the amphoteric surfactant can be polyoxypropylene propyl ether, lauryl betaine, cocamidopropyl betaine, 3,7,11-trimethyldodecan-3-ol, neopentyl glycol dinonanoate, ethambutol, N,N′-bis(3-aminopropyl)-1,3-propanediamine, di(3-aminopropoxy)ethane, or a mixture thereof. However, the aforementioned examples describe only one of the embodiments of the present disclosure, and the present disclosure is not intended to be limited thereto. Preferably, the amphoteric surfactant is polyoxypropylene propyl ether, ethambutol, N,N′-bis(3-aminopropyl)-1,3-propanediamine, or di(3-aminopropoxy)ethane. More preferably, the amphoteric surfactant is polyoxypropylene propyl ether or ethambutol.

In one embodiment, a content of the amphoteric surfactant is 2% to 20% (i.e., any positive real number ranging between 2% and 20%) of a total weight of the flux cleaning composition. For example, the content of the amphoteric surfactant is 2%, 2.5%, 3%, 4%, 5%, 5.5%, 6%, 7%, 8%, 9%, 10%, 10.5%, 11%, 12%, 13%, 14%, 15%, 15.5%, 16%, 17%, 18%, 19%, or 20%. If the content of the amphoteric surfactant is less than 2%, the cleaning effect of the flux cleaning composition on the rosin flux will be poor. If the content of the amphoteric surfactant is greater than 20%, excessive bubbles will be generated during use of the flux cleaning composition. In an exemplary embodiment, the content of the amphoteric surfactant ranges between 5% and 10%.

However, after being heated, the color of the above-mentioned amphoteric surfactant may become darker. In order to prevent the darker color of the amphoteric surfactant from affecting use of the flux cleaning composition, the flux cleaning composition of the present disclosure further includes a reducing agent. Accordingly, oxidation of the amphoteric surfactant can be avoided, and component stability of the flux cleaning composition can be maintained. In other words, the reducing agent of the present disclosure is an antioxidant of the above-mentioned amphoteric surfactant.

For example, the reducing agent can be tin(II) chloride, iron(II) sulfate, titanium(III) chloride, reduced iron powder, oxalic acid, sodium thiosulfate, sodium sulfite, hypophosphorous acid, dithiothreitol, or a mixture thereof. However, the aforementioned examples describe only one of the embodiments of the present disclosure, and the present disclosure is not intended to be limited thereto. In an exemplary embodiment of the present disclosure, the reducing agent is tin(II) chloride or sodium sulfite.

In one embodiment, a content of the reducing agent is 0.1% to 2% (i.e., any positive real number ranging between 0.1% and 2%) of the total weight of the flux cleaning composition. For example, the content of the reducing agent is 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, or 2%. If the content of the reducing agent is less than 2%, an anti-oxidation effect of the amphoteric surfactant will be poor. If the content of the reducing agent is greater than 2%, manufacturing costs of the flux cleaning composition will be unnecessarily increased in the present disclosure. In an exemplary embodiment, the content of the reducing agent ranges between 0.5% and 1%. It is worth mentioning that, in order to effectively utilize the reducing agent and achieve an optimal anti-oxidation effect of the amphoteric surfactant, a weight ratio of the amphoteric surfactant to the reducing agent ranges between 15:1 and 20:1, such as 15:1, 16:1, 17:1, 18:1, 19:1, or 20:1.

Since performance of the flux cleaning composition may be affected by easy dissolution of metal ions when a printed circuit board is being cleaned, the flux cleaning composition of the present disclosure further includes a chelating agent that is capable of forming coordination or chelation with metal or metal oxides. In this way, the cleaning ability of the flux cleaning composition can be maintained. In one embodiment, a content of the chelating agent is 5% to 10% (i.e., any positive real number ranging between 5% and 10%) of the total weight of the flux cleaning composition. For example, the content of the chelating agent is 5%, 6%, 7%, 8%, 9%, or 10%. If the content of the chelating agent is less than 5%, the obtained cleaning composition cannot overcome the problem of being affected by the metal ions. If the content of the chelating agent is greater than 10%, there are no economic benefits. In an exemplary embodiment, the content of the chelating agent ranges between 6% and 8%.

For example, the chelating agent can be ethylenediamine, 2,2′-bipyridine, 1,10-phenanthroline, oxalate, ethylenediaminetetraacetic acid (EDTA), 1,2-bis(dimethylarsino)benzene, citric acid, malic acid, or a mixture thereof. However, the aforementioned examples describe only one of the embodiments of the present disclosure, and the present disclosure is not intended to be limited thereto. In an exemplary embodiment of the present disclosure, the chelating agent is citric acid or malic acid, which has a good stability in the flux cleaning composition of the present disclosure.

An organic solvent is used in the flux cleaning composition of the present disclosure to uniformly mix the amphoteric surfactant, the reducing agent, and the chelating agent. For example, the organic solvent can be ethylene glycol monoalkyl ether, ethylene glycol monophenyl ether, diethylene glycol monophenyl ether, diethylene glycol monoalkyl ether, dipropylene glycol monoalkyl ether, diethylene glycol dialkyl ether, or a mixture thereof. However, the aforementioned examples describe only one of the embodiments of the present disclosure, and the present disclosure is not intended to be limited thereto. In an exemplary embodiment of the present disclosure, the organic solvent is ethylene glycol monoalkyl ether, so as to maintain the stability of the flux cleaning composition and prevent crystallization.

In one embodiment, a content of the organic solvent is 70% to 90% (i.e., any positive real number ranging between 70% and 90%) of the total weight of the flux cleaning composition. For example, the content of the organic solvent is 70%, 75%, 80%, 85%, or 90%. If the content of the organic solvent is less than 70%, the amphoteric surfactant, the reducing agent, and the chelating agent cannot be uniformly mixed, thereby affecting formulation stability of the flux cleaning composition. If the content of the organic solvent is greater than 90%, an effective cleaning concentration of the flux cleaning composition will be so low as to affect the cleaning effect of the flux cleaning composition. In an exemplary embodiment, the content of the organic solvent ranges between 80% and 85%.

Furthermore, in order for the flux cleaning composition of the present disclosure to be suitable for use under an operating temperature of about 75° C., a flash point of the organic solvent selected in the present disclosure preferably ranges between 100° C. and 110° C., and is more preferably 105° C. At the same time, in order to prevent the flux cleaning composition from causing corrosion on a circuit board under the operating temperature, a pH of the organic solvent is any positive real number ranging between 8 and 9.

Based on the total weight of the flux cleaning composition being 100%, in addition to the amphoteric surfactant, the reducing agent, the chelating agent, and the organic solvent, the flux cleaning composition of the present disclosure further includes a remaining amount of water. In other words, a content of the water is 5% to 20% (i.e., any positive real number ranging between 5% and 20%) of the total weight of the flux cleaning composition. For example, the content of the water is 5%, 10%, 15%, or 20%. Preferably, the content of the water is 8% to 13% of the total weight of the flux cleaning composition. It is worth mentioning that, in order to obtain a stable flux cleaning composition by uniformly mixing the amphoteric surfactant, the reducing agent, and the chelating agent, a ratio of the organic solvent to the water can be any positive real number ranging between 10 and 35, such as 10, 12, 14, 17.8, 22.9, 25, 28, or 32. Preferably, said ratio ranges between 15 and 32.

In the following descriptions, examples are further provided for illustrative purposes, such that merits of the flux cleaning composition of the present disclosure will be apparent to those skilled in the art. However, these examples are not to be construed as limiting the scope of the present disclosure.

In the examples below, different components can be mixed simultaneously or in an arbitrary order. Unless indicated otherwise, all percentage concentrations are expressed as wt % in the present disclosure.

### Example 1

8% of polyoxypropylene propyl ether, 0.5% of tin(II) chloride, 7% of citric acid, 80% of ethylene glycol monoalkyl ether, and 4.5% of water are mixed, uniformly stirred, and filtered, so as to obtain a flux cleaning composition El of Example 1 in the present disclosure.

### Example 2

8% of polyoxypropylene propyl ether, 0.5% of sodium sulfite, 7% of citric acid, 80% of ethylene glycol monoalkyl ether, and 4.5% of water are mixed, uniformly stirred, and filtered, so as to obtain a flux cleaning composition E2 of Example 2 in the present disclosure.

### Example 3

9% of polyoxypropylene propyl ether, 0.5% of hypophosphorous acid, 7% of citric acid, 80% of ethylene glycol monoalkyl ether, and 3.5% of water are mixed, uniformly stirred, and filtered, so as to obtain a flux cleaning composition E3 of Example 3 in the present disclosure.

### Example 4

10% of polyoxypropylene propyl ether, 0.5% of dithiothreitol, 7% of citric acid, 80% of ethylene glycol monoalkyl ether, and 2.5% of water are mixed, uniformly stirred, and filtered, so as to obtain a flux cleaning composition E4 of Example 4 in the present disclosure.

### Example 5

8% of ethambutol, 0.5% of tin(II) chloride, 7% of citric acid, 80% of ethylene glycol monoalkyl ether, and 4.5% of water are mixed, uniformly stirred, and filtered, so as to obtain a flux cleaning composition E5 of Example 5 in the present disclosure.

### Example 6

8% of ethambutol, 0.5% of sodium sulfite, 7% of citric acid, 80% of ethylene glycol monoalkyl ether, and 4.5% of water are mixed, uniformly stirred, and filtered, so as to obtain a flux cleaning composition E6 of Example 6 in the present disclosure.

### Example 7

9% of ethambutol, 0.5% of hypophosphorous acid, 7% of citric acid, 80% of ethylene glycol monoalkyl ether, and 3.5% of water are mixed, uniformly stirred, and filtered, so as to obtain a flux cleaning composition E7 of Example 7 in the present disclosure.

### Example 8

10% of ethambutol, 0.5% of dithiothreitol, 7% of citric acid, 80% of ethylene glycol monoalkyl ether, and 2.5% of water are mixed, uniformly stirred, and filtered, so as to obtain a flux cleaning composition E8 of Example 8 in the present disclosure.

### Example 9

15% of polyoxypropylene propyl ether, 1% of tin(II) chloride, 7% of malic acid, 70% of ethylene glycol monoalkyl ether, and 7% of water are mixed, uniformly stirred, and filtered, so as to obtain a flux cleaning composition E9 of Example 9 in the present disclosure.

### Example 10

15% of ethambutol, 1% of sodium sulfite, 7% of malic acid, 70% of ethylene glycol monoalkyl ether, and 7% of water are mixed, uniformly stirred, and filtered, so as to obtain a flux cleaning composition E10 of Example 10 in the present disclosure.

### Comparative Example

Comparative Example C is prepared by mixing, uniformly stirring, and filtering 15% of polyoxypropylene propyl ether, 7% of citric acid, 70% of ethylene glycol monoalkyl ether, and 8% of water.

In order to measure and evaluate a cleaning force, an evaluation board having residues of the rosin flux is immersed into the flux cleaning composition at 75° C., and is purged and dried with nitrogen. After the above-mentioned cleaning step, the evaluation board is observed by use of a microscope, and a visual check is performed. The evaluation board that is without the flux residues is labelled with ‘O’, and the evaluation board having the flux residues is labelled with ‘X’.

In a color depth test, the flux cleaning composition is heated at 95° C. for 168 hours, and a colorimeter is used to measure a color depth. The lower a color depth value is, the lighter a color is. Ratios of components in each example and experiment results are recorded in Table 1.

TABLE 1

| | | | | | | Cleaning | Color depth |
|---|---|---|---|---|---|---|---|
| | Ratio of each component (wt %) | | | | | force | after being |
| | Amphoteric | Reducing | Chelating | Organic | | New | heated |
| Composition | surfactant | agent | agent | solvent | Water | liquid | Unit: G |
| E1 | 8 | 0.5 | 7 | 80 | 4.5 | ◯ | 7.3 |
| E2 | 8 | 0.5 | 7 | 80 | 4.5 | ◯ | 7.5 |
| E3 | 9 | 0.5 | 7 | 80 | 3.5 | ◯ | 8.1 |
| E4 | 10 | 0.5 | 7 | 80 | 2.5 | ◯ | 5.6 |
| E5 | 8 | 0.5 | 7 | 80 | 4.5 | ◯ | 4.6 |
| E6 | 8 | 0.5 | 7 | 80 | 4.5 | ◯ | 4.8 |
| E7 | 9 | 0.5 | 7 | 80 | 3.5 | ◯ | 7.1 |
| E8 | 10 | 0.5 | 7 | 80 | 2.5 | ◯ | 8.2 |
| E9 | 15 | 1 | 7 | 70 | 7 | ◯ | 8.6 |
| E10 | 15 | 1 | 7 | 70 | 7 | ◯ | 10.1 |
| C | 15 | 0 | 7 | 70 | 8 | ◯ | 16.3 |

As shown in Table 1, without containing haloalkanes, the flux cleaning composition of the present disclosure uses the amphoteric surfactant as the main cleaning component, and is indeed capable of cleaning the rosin flux. In the present disclosure, through specific composition ratios, the flux cleaning composition can be configured to have a strong cleaning force and be safe and eco-friendly by merely using the amphoteric surfactant, the reducing agent, the chelating agent, the organic solvent, and the water. In practical application, said flux cleaning composition is economically beneficial in cleaning of the rosin flux.

It should be noted that, as shown in Comparative Example C, the color of the flux cleaning composition that includes the amphoteric surfactant becomes darker after being heated. Relative to the content of the amphoteric surfactant, a specific content of the reducing agent is added in Examples 1 to 10 of the present disclosure, such that the problem of the darker color of the flux cleaning composition after being heated can be improved as compared with Comparative Example C. By using ethambutol in cooperation with tin(II) chloride, Example 5 has an optimal effect of improving the darker color of the flux cleaning composition after being heated.

### Beneficial Effects of the Embodiments

In conclusion, in the flux cleaning composition provided by the present disclosure, by virtue of “the flux cleaning composition, based on a total weight thereof being 100%, including: 2% to 20% of an amphoteric surfactant; 0.1% to 2% of a reducing agent; 5% to 10% of a chelating agent; 70% to 90% of an organic solvent; and 5% to 20% of water,” a formula that does not contain the haloalkanes but is still capable of effectively cleaning a flux can be provided, so as to replace a conventional haloalkane-based cleaning agent.

Specifically, the reducing agent is added to prevent occurrence of color change caused by oxidation of the amphoteric surfactant during heating. In order to use the reducing agent in a cost-effective manner, the weight ratio of the amphoteric surfactant to the reducing agent ranges between 15:1 and 20:1 in the flux cleaning composition of the present disclosure.

Furthermore, since the flux cleaning composition of the present disclosure simultaneously includes the amphoteric surfactant, the reducing agent, and the chelating agent, the ratio of the organic solvent to the water is controlled to range between 10 and 35 (preferably between 15 and 32), so as to uniformly mix the amphoteric surfactant, the reducing agent, and the chelating agent and achieve an optimal use effect.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A flux cleaning composition, based on a total weight thereof being 100%, comprising:
2% to 20% of an amphoteric surfactant;
0.1% to 2% of a reducing agent;
5% to 10% of a chelating agent;
70% to 90% of an organic solvent; and
5% to 20% of water.

2. The flux cleaning composition according to claim 1, wherein the amphoteric surfactant is alkanolamine.

3. The flux cleaning composition according to claim 1, wherein the amphoteric surfactant is polyoxypropylene propyl ether, lauryl betaine, cocamidopropyl betaine, 3,7,11-trimethyldodecan-3-ol, neopentyl glycol dinonanoate, ethambutol, N,N′-bis(3-aminopropyl)-1,3-propanediamine, di(3-aminopropoxy)ethane, or a mixture thereof.

4. The flux cleaning composition according to claim 1, wherein the reducing agent is tin(II) chloride, iron(II) sulfate, titanium(III) chloride, reduced iron powder, oxalic acid, sodium thiosulfate, sodium sulfite, hypophosphorous acid, dithiothreitol, or a mixture thereof.

5. The flux cleaning composition according to claim 1, wherein the chelating agent is ethylenediamine, 2,2′-bipyridine, 1,10-phenanthroline, oxalate, ethylenediaminetetraacetic acid, 1,2-bis(dimethylarsino)benzene, citric acid, malic acid, or a mixture thereof.

6. The flux cleaning composition according to claim 1, wherein the organic solvent is ethylene glycol monoalkyl ether, ethylene glycol monophenyl ether, diethylene glycol monophenyl ether, diethylene glycol monoalkyl ether, dipropylene glycol monoalkyl ether, diethylene glycol dialkyl ether, or a mixture thereof.

7. The flux cleaning composition according to claim 1, wherein a content of the amphoteric surfactant ranges between 5% and 10%.

8. The flux cleaning composition according to claim 1, wherein a content of the reducing agent ranges between 0.5% and 1%.

9. The flux cleaning composition according to claim 1, wherein a content of the chelating agent ranges between 6% and 8%.

10. The flux cleaning composition according to claim 1, wherein a content of the organic solvent ranges between 80% and 85%.

11. The flux cleaning composition according to claim 1, wherein a content of the water ranges between 8% and 13%.

12. The flux cleaning composition according to claim 1, wherein a flash point of the organic solvent ranges between 100° C. and 110° C.

13. The flux cleaning composition according to claim 1, wherein a pH of the organic solvent ranges between 8 and 9.

14. The flux cleaning composition according to claim 1, wherein a weight ratio of the amphoteric surfactant to the reducing agent ranges between 15:1 and 20:1.

15. The flux cleaning composition according to claim 1, wherein a chroma of the flux cleaning composition is less than 15 G after being heated at 95° C. for 168 hours.
